(19) United States
(12) Patent Application Publication
(10) Pub. No.: US 2026/0260042 A1
(43) Pub. Date: Sep. 3, 2026

(54) GENERATIVE AI WORKFLOW FOR FLOW ASSURANCE ANALYSIS IN NATURAL GAS TRANSPORT OPERATIONS

(71) Applicant: Schlumberger Technology Corporation, Sugar Land, TX (US)

(72) Inventors: Carla Jordana Santiago, Houston, TX (US); Andrew Reisdorf, Houston, TX (US)

(21) Appl. No.: 19/550,983

(22) Filed: Feb. 26, 2026

Related U.S. Application Data
(60) Provisional application No. 63/764,724, filed on Feb. 28, 2025.

(51) Int. Cl. G06F 30/27; G06F 16/9038; G06F 113/08

(52) U.S. Cl. CPC G06F 30/27; G06F 16/9038; G06F 2113/08

(57) ABSTRACT

A method for performing a flow assurance analysis in a pipeline includes receiving first input data related to a gas in the pipeline. The method also includes building or updating a model based upon the first input data. The method also includes receiving second input data including a query from a user. The method also includes identifying one or more topics to which the second input data is most closely related. The method also includes generating an answer to the query using the model based upon the one or more topics.

### CROSS-REFERENCE TO RELATED APPLICATIONS

This application claims priority to U.S. Provisional Patent Application No. 63/764,724, filed on Feb. 28, 2025, which is incorporated by reference.

### BACKGROUND

Hydrate is a substance that contains water or its constituent elements. Hydrate formation in natural gas flowlines and pipelines poses flow restriction and safety risks, leading to rigorous flow assurance studies. What is needed is an improved system and method that enhances flow assurance studies in natural gas transport operations by reducing manual effort and improving decision-making.

### SUMMARY

A method for performing a flow assurance analysis in a pipeline is disclosed. The method includes receiving first input data related to a gas in the pipeline. The method also includes building or updating a model based upon the first input data. The method also includes receiving second input data including a query from a user. The method also includes identifying one or more topics to which the second input data is most closely related. The method also includes generating an answer to the query using the model based upon the one or more topics.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a method for performing a flow assurance analysis in a pipeline, according to an embodiment.

FIG. 3 illustrates a schematic view of the method, according to an embodiment.

FIGS. 4A and 4B illustrate PVT compositional reports for a wellhead (FIG. 4A) and low-pressure sales (FIG. 4B), according to an embodiment.

FIG. 5 illustrates a schematic view of a gathering system, according to an embodiment.

FIG. 6 illustrates a schematic view of a compressor booster station, according to an embodiment.

FIG. 7 illustrates a plot of the hydrate formation temperature at each active booster station in the network, according to an embodiment.

FIG. 8 illustrates a plot showing temperature versus pressure, according to an embodiment.

FIG. 9 illustrates a plot showing a normalized methanol rate for each station in the summer and winter, according to an embodiment.

FIG. 10 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

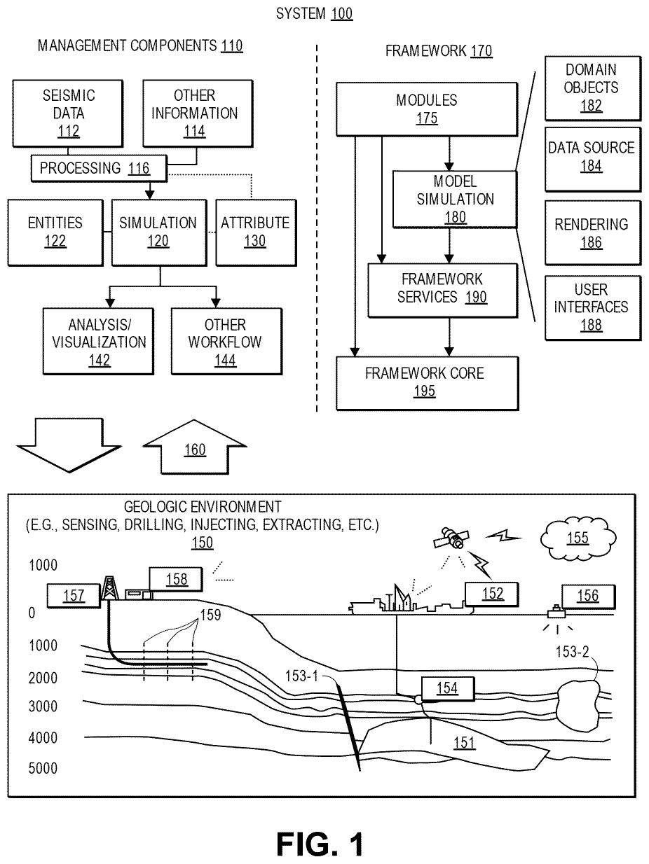

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 may include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® NET® framework (Redmond, Washington), which provides a set of extensible object classes. In the .NET® framework, an object class encapsulates a module of reusable code and associated data structures. Object classes may be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

As an example, the simulation component 120 may include one or more features of a simulator such as SYMMETRY software (SLB, Houston, Texas). More particularly, SYMMETRY may process workflows in a single integrated environment with accurate thermodynamic fluid representation and consistent modeling across multiple disciplines including process, production, and HSE. The simulator integrates steady-state and transient (e.g., dynamic) analyses that may be tailored for each domain. This approach enables users to optimize processes in upstream, midstream, and downstream sectors while maximizing profits and minimizing capital expenditures. It may also help reduce emissions, energy consumption, and waste.

As an example, the simulation component 120 may include one or more features of a simulator such as PIPESIM (SLB, Houston, Texas). More particularly, PIPESIM is a steady-state multiphase flow simulator that incorporates the three areas of flow modeling: multiphase flow, heat transfer and fluid behavior.

As an example, the simulation component 120 may include one or more features of a simulator such as OLGA™ (SLB, Houston, Texas). More particularly, OLGA™ is a dynamic multiphase flow simulator that models transient flow (e.g., time-dependent behaviors) to maximize production potential. Transient modeling may be a component for feasibility studies and field development design. Dynamic simulation may be useful in deep water and may be used in both offshore and onshore developments to investigate transient behavior in pipelines and wellbores. Transient simulation with the OLGA™ simulator provides an added dimension to steady-state analysis by predicting system dynamics, such as time-varying changes in flow rates, fluid compositions, temperature, solids deposition, and operational changes.

In an example embodiment, the management components 110 may include features of a commercially available framework such as the PETREL© seismic to simulation software framework (SLB, Houston, Texas). The PETREL© framework provides components that allow for optimization of exploration and development operations. The PETREL© framework includes seismic to simulation software components that may output information for use in increasing reservoir performance, for example, by improving asset team productivity. Through use of such a framework, various professionals (e.g., geophysicists, geologists, and reservoir engineers) may develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software may include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications may display their data while the user interfaces 188 may provide a common look and feel for application user interface components.

As an example, the domain objects 182 may include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project may be accessed and restored using the model simulation layer 180, which may recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a workstep may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL© software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

### Generative AI Workflow for Flow Assurance Analysis in Natural Gas Transport Operations

The present disclosure includes a multi-agent generative artificial intelligence (AI) workflow (i.e., method) that integrates large language models (LLMs) with a thermodynamic engine to automate gas compositional modeling, thermodynamic property queries, hydrate risk identification, and inhibitor injection scenario comparisons. The multi-agent method may be used to automate gas compositional data extraction and/or to update thermodynamical models in a process simulator (e.g., symmetry) to generate results regarding thermodynamic properties of fluids and flow assurance recommendations.

The method is two-fold: (1) flow assurance applied to natural gas transportation and (2) generative AI for workflow automation. The method leverages a generative AI framework to automate the process of extracting gas compositional data, generating thermodynamic models, and performing flow assurance studies regarding hydrate risk assessment and mitigation.

### Exemplary Method

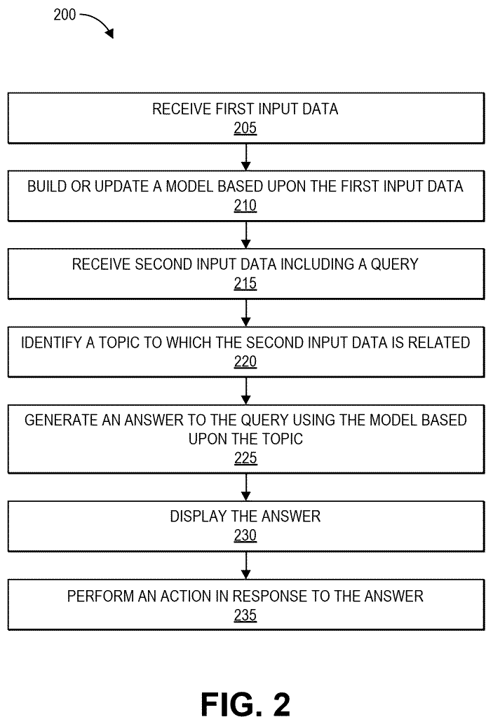

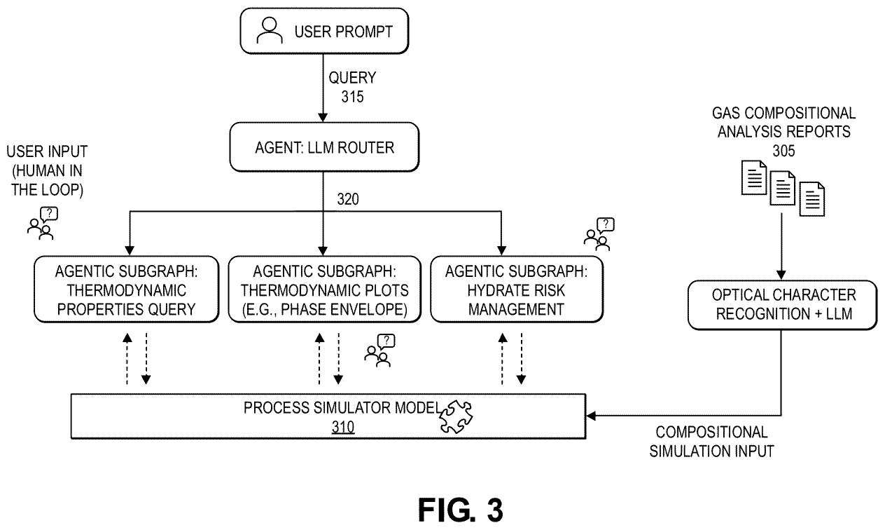

FIG. 2 illustrates a flowchart of a method 200 for performing a flow assurance analysis in a pipeline, according to an embodiment. The method 200 integrates a multi-agent system with a thermodynamic engine from a process simulator to automate flow assurance studies. An illustrative order of the method 200 is provided below; however, one or more portions of the method 200 may be performed in a different order, simultaneously, repeated, or omitted. At least a portion of the method 200 may be performed using a computing system. FIG. 3 illustrates a schematic view of the method 200 in FIG. 2.

The method 200 may include receiving first input data, as at 205. This is also shown at 305 in FIG. 3. The first input data may be or include a composition of a gas in the pipeline, a pressure of the gas in the pipeline, and/or a temperature of the gas in the pipeline. The first input data may be extracted from data sources with different and/or unstructured formats. The first input data may be extracted using optical character recognition (OCR) and/or large language models (LLMs).

The method 200 may also include building or updating a model based upon the first input data, as at 210. This is also shown at 310 in FIG. 3. The model may be or include a thermodynamic engine in a physics-based simulator. The thermodynamic engine may be integrated into an agentic framework through a plurality of tool calls.

The method 200 may also include receiving second input data, as at 215. This is also shown at 315 in FIG. 3. The second input data may be or include a query from a user. In an example, the query may be or include a thermodynamic property of the gas, a phase boundary of the gas, a phase envelope curve corresponding to the gas, a hydrate formation curve corresponding to the gas, a hydrate formation risk evaluation in the pipeline, an inhibitor injection rate recommendation into the pipeline, and/or a sensitivity of an effect of gas distribution temperature and/or pressure on hydrate inhibitor rates into the pipeline.

The method 200 may also include identifying one of a plurality of topics to which the second input data is most closely related, as at 220. This is also shown at 320 in FIG. 3. The identification may be made by a graph-based multi-agent system that is structured into a plurality of sub-graphs. The topics may be or include thermodynamic properties of the gas, thermodynamic plots and phase envelopes of the gas, hydrate formation curves, hydrate risk management in the pipeline, performing analysis and sensitivity on hydrate mitigation measures, or a combination thereof.

The method 200 may also include generating an answer to the query using the model based upon the identification of the topic, as at 225.

The method 200 may also include displaying the answer, as at 230.

The method 200 may also include performing an action in response to the answer, as at 235. The action may be or include generating and/or transmitting a signal that recommends, instructs, or causes a physical action to occur. The physical action may be or include varying the composition of the gas, varying the pressure of the gas, varying the temperature of the gas, varying a flow rate of the gas, actuating a valve in the pipeline, or a combination thereof.

The proposed multi-agent method 200 may uniquely integrates AI-driven data extraction, thermodynamic simulations, and a multi-agent architecture, reducing manual intervention and enhancing real-time decision-making. The method 200 may reduce the time and technical barriers associated with setting up thermodynamic simulations. By automating flow assurance workflows and enabling natural language interaction, the method 200 may reduce manual data transcription errors and allow engineers to rapidly obtain flow assurance insights.

The method 200 may reduce data transcription errors due to manual data ingestion, the use of advanced software expertise for simulation case setup, and the use of advanced coding skills for insights generation. The method 200 may do so by reducing manual data ingestion errors by automating data extraction, which may save time. The method 200 may also allow users to perform simulations and generate visualizations without knowledge of software syntax or advanced coding skills. The method 200 may be used to perform or assess flow assurance workflows, such as wax and asphaltenes risk management, sand production, and corrosion studies. The method 200 may provide automated compositional data ingestion and simulation case setup, so that a user without advanced software expertise or coding skills may perform the method or understand the results. The method 200 may allow the user to perform simulation tasks using natural language.

### Examples of Pressure-Volume-Temperature (PVT) Report

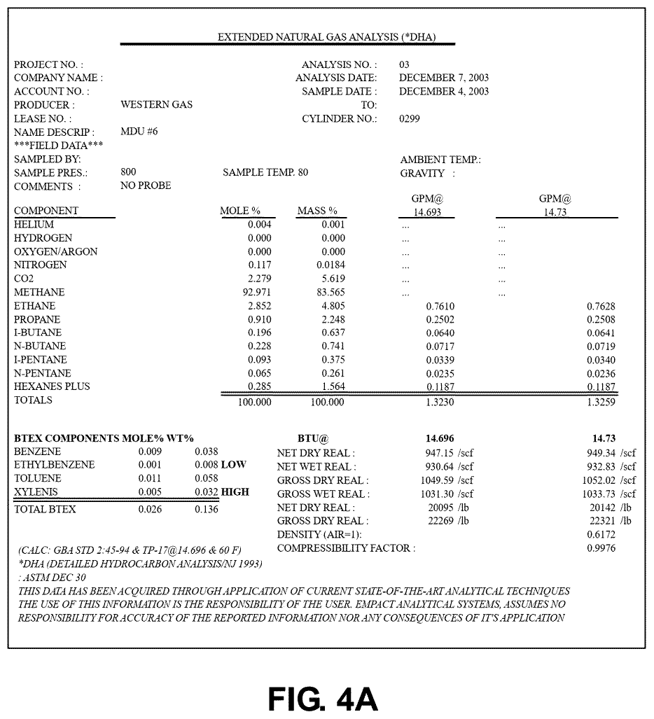

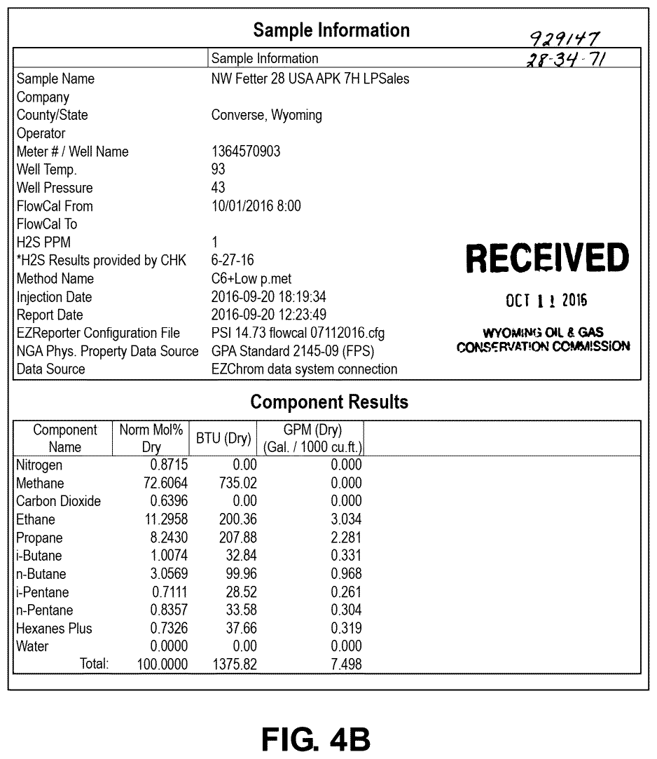

PVT sampling and report generation is a practice in the oilfield. It is a regulatory standard, and the basis of operational decisions and commercial conditions (including pricing of natural gas). Sampling may occur in different locations (i.e., sampling points) in the network (e.g., wellhead, low pressure headers, high pressure headers). FIGS. 4A and 4B illustrate PVT compositional reports for a wellhead (FIG. 4A) and low-pressure sales (FIG. 4B), according to an embodiment. This data is publicly available from Wyoming Oil and Gas Conservation Commission (WOGCC).

The information contained in these reports may be used across functions within a company. Below are a few examples of how information extracted from the reports may affect different stakeholders (e.g., reservoir, completions, production, drilling, cementing, etc.) within an organization.
A reservoir engineer may use this information to build and calibrate reservoir models, affecting history matching, reserves calculations, and field development planning.
A production engineer may use gas/oil/water ratios and phase envelopes to plan efficient surface facilities, select artificial lift methods, and manage flow assurance (e.g., hydrate, wax, asphaltene mitigation).
A drilling engineer may use this information for planning drilling campaigns, particularly understanding drilling risks, well control strategies, drilling mud composition, etc.
On the commercial side, this information may determine the sales contract parameters (e.g., calorific value, H2S/CO2 content, vapor pressure) for natural gas sales. Pricing mechanisms may be directly tied to PVT-determined product specifications.

Given that an operator may manage hundreds of wells and sampling points in different sections of a pipe network, the action of reviewing reports and extracting relevant information becomes a cumbersome task. Reviewing and extracting information from PVT reports in large distributed networks is labor-intensive, prone to error, and may slow down operational efficiency and responsiveness. Furthermore, additional specialized knowledge is beneficial when preparing PVT data for use in engineering simulators (such as compositional reservoir, pipeline, or process simulators). This additional layer of expertise intensifies the operational burden, increases turnaround time for insights, and raises the risk of suboptimal or erroneous decision-making. AI-driven data extraction, thermodynamic simulations, and a multiagent architecture may reduce manual intervention, enhance timely decision-making, and lower technical barriers associated with assembling thermodynamic simulations.

### Example for Hydrate Formation and Inhibition

Within the natural gas pipeline network, compressor booster stations hold a role in orchestrating gas transportation from individual well sites to end users. They may be strategically situated along the gathering and transportation network to effectively maintain pressure and flow of gas to market. The formation of hydrates in natural gas systems has been a widely common problem in the oil and gas industry. Methanol has been used as a hydrate inhibitor for nearly as long as the hydrate problem has existed.

Identifying the temperature in which hydrates form is useful in the dosage of inhibitors and the safe operation of gas gathering networks. If the ambient temperature is reduced at the wellhead (e.g., during winter), the external temperature may drop to a value close to the hydrate formation temperature, leading to hydrate formation in the pipe. This poses economic risks due to production disruption and/or safety risks (e.g., hydrates may quickly block pipes).

The case study below is an example of a workflow that enables accurate and timely identification of a hydrate risk, allowing quick mitigation actions.

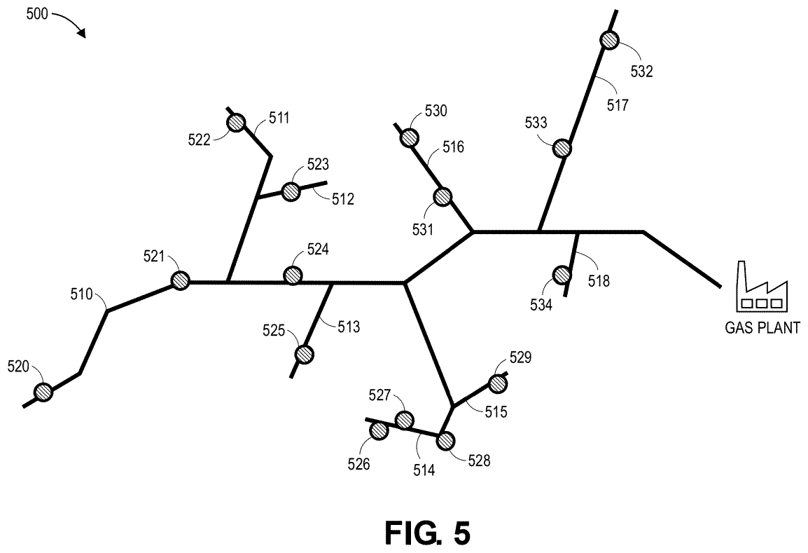

FIG. 5 illustrates a schematic view of a gathering system 500 including a plurality of pipelines 510-518, according to an embodiment. A workflow for the gathering system 500 may include multiple analytical pipelines that perform the following tasks:
Extract, index, and store gas composition, temperature, and pressure from unstructured files (e.g., PVT reports) for identified sampling points (e.g., wellhead across the network) using a large language model and a vector database.
Receive a user query and translates natural language into actions through tool calls. The actions may include:
   retrieving sample information from a vector store;
   retrieving gathering network information from structured data stored in a database;
   modifying inputs and running a simulation engine;
   collecting additional information from external sources (e.g., weather forecast)
   synthesizing a response that combines simulation results, retrieved information, and reasoning (e.g., through prompt engineering);
   generating visualizations (e.g., plots and tables) and summary reports; and/or
   distributing summary reports to stakeholders for rapid decision making (e.g., through an e-mail distribution list).

The workflow may start with the user uploading PVT reports from different sampling points in the network. The composition and operating conditions may be stored and made available to the multi-agent system. A physics-based proxy model of a booster station may be used to evaluate methanol consumption in the gathering system (e.g., containing 18 compressor booster stations 520-532). At each booster station 520-532, the gas may be compressed (e.g., using three stages with interstage and final stage cooling). The physics-based model created for the booster station 520-532 may contain a compressor, a cooler, and a scrubber for each stage.

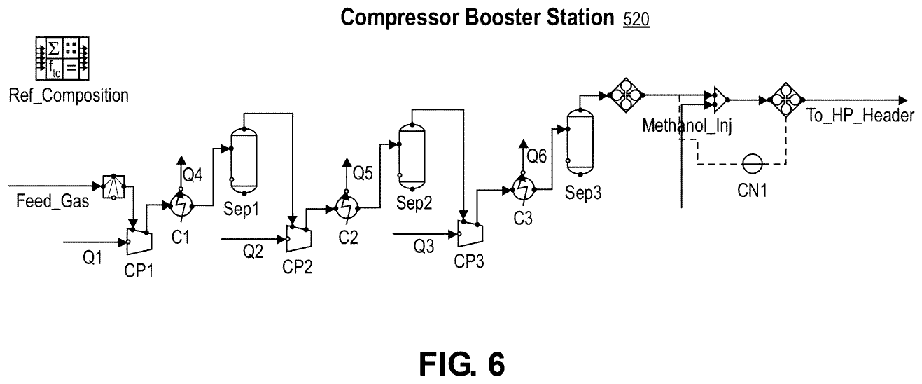

FIG. 6 illustrates a schematic view of a compressor booster station 520, according to an embodiment. The following is an example of the user story for the multiagent system in the scenario mentioned above:
AI: Hello, I am a Flow Assurance Advisor. How may I help?
User: Please indicate which booster stations are currently operating in the high-pressure gathering network?
AI: Reasoning: The user is asking about components within the gathering network. Consult the database to find the booster stations in the network and their status.
   The table below is an exemplary list of active booster stations:

| Station Name | Status |
|---|---|
| C-101 | Active |
| C-102 | Active |
| C-103 | Active |
| C-104 | Active |
| C-105 | Active |
| C-106 | Active |
| C-107 | Active |
| C-108 | Active |
| C-109 | Active |
| C-110 | Active |
| C-111 | Active |
| C-112 | Active |
| C-113 | Active |
| C-114 | Active |
| C-115 | Active |
| C-117 | Active |
| C-118 | Active |
| C-119 | Active |

User: What is the hydrate formation temperature on those booster stations?
AI: Reasoning: The user is asking for hydrate formation temperature. Retrieve the composition for each booster station from the vector store, and spawn thermodynamic calculations with each retrieved composition concurrently. Synthesize the results and provide recommendations.

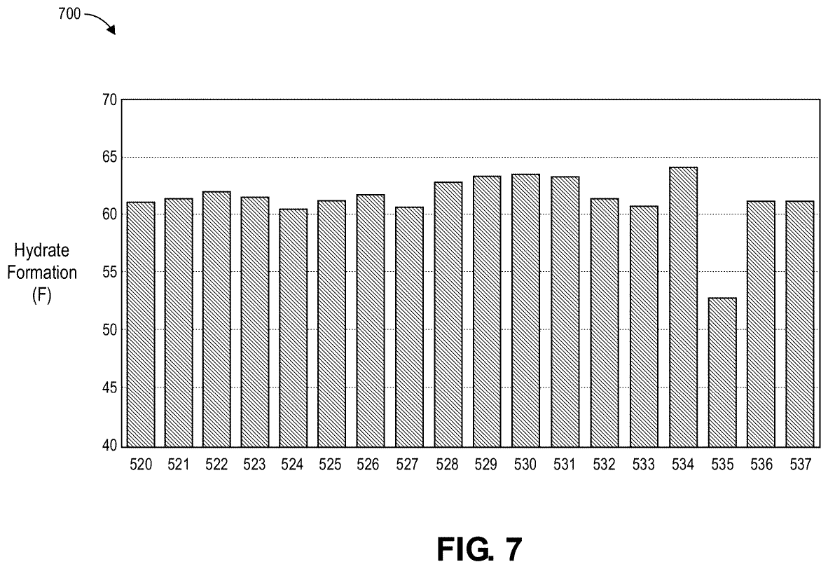

FIG. 7 illustrates a plot 700 of the hydrate formation temperature at each active booster station in the network, according to an embodiment. Based on operating conditions, the hydrate formation temperature is between 60 deg F. and 65 deg F. for almost every station.
User: What is your recommendation for hydrate inhibition under different seasons (summer/winter)?
AI: Reasoning: The user is asking for recommendations on hydrate inhibition. Synthesize an answer based on my role as flow assurance advisor and my accumulated knowledge.
   For hydrate inhibition in gas gathering networks, the approach generally depends on operating temperature, pressure, and seasonal variations:
Summer: Higher ambient temperatures mean pipelines are less likely to reach hydrate formation conditions. Inhibitor (e.g., methanol or MEG) dosage may be reduced, but confirm pipeline minimum temperatures, as local cooling and Joule-Thomson effects may still bring temperatures close to hydrate conditions. Regularly review process simulations and pressure/temperature logs to assess the risk.
Winter: Lower ambient temperatures increase hydrate formation risk, especially during shutdowns or in exposed surface lines. Inhibitor dosage should be increased accordingly-sometimes by 50% or more-depending on the calculated hydrate formation temperature for your specific composition and pressure profile. Consider continuous injection or higher batch doses, and monitor for localized cold spots (e.g., valve stations, risers).

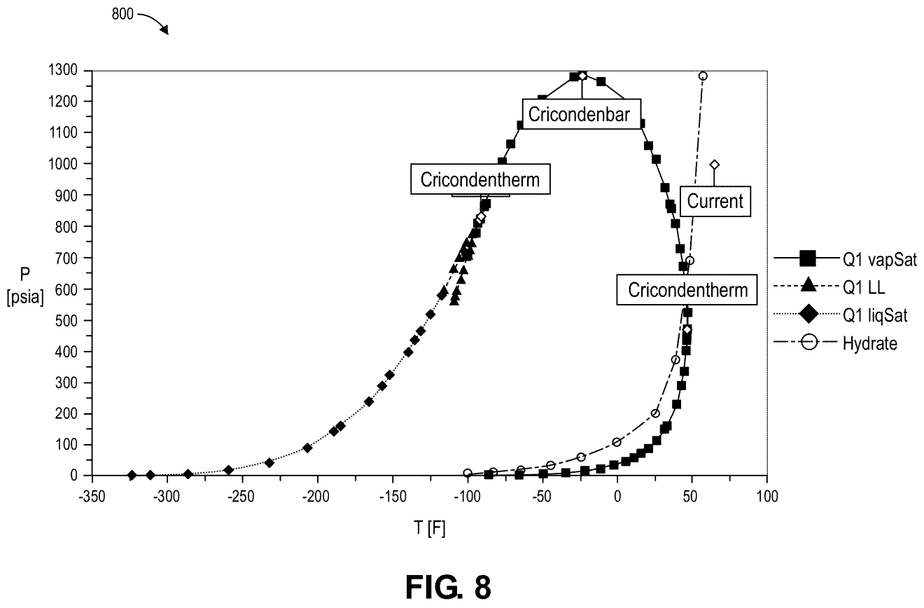

FIG. 8 illustrates a plot 800 showing a phase envelope for one of the compressor booster stations, according to an embodiment.
User: Let's look at booster station C-106. Please provide a phase envelope for the gas at inlet of the station.
AI: Reasoning: The user is asking for the phase envelope at station C-106. Retrieve the phase envelope from thermodynamic engine. Synthesize results. Below is the phase envelope at station C-106, including the hydrate formation curve. Under the current operating conditions, the hydrate formation temperature is 60 deg F. You have a 10 deg F. approach temperature (difference between hydrate formation temperature and operating temperature). Consider dosing a hydrate inhibitor to increase the approach temperature margin.
User: The hydrate formation temperature looks high. For booster station C-106, what is the expected average methanol consumption for hydrate inhibition over the summer and winter months in Calgary?
AI: Reasoning: The user is asking for methanol consumption at C-106 in different seasons. Use a weather API to collect historical ambient temperature during winter and summer months over the past year in Calgary, AB. Update the model and run thermodynamic calculations at booster station C-106. Synthesize results and provide recommendations.
   For booster station C-106 in Calgary, the expected average methanol consumption for hydrate inhibition is approximately 23 gallons (US) per MMSCF during the summer months, and 37 gallons (US) per MMSCF during the winter months. This reflects increased inhibitor dosage requirements in winter due to lower ambient temperatures and heightened hydrate risk. Please adjust actual dosing based on real-time operational data, gas composition, and ongoing monitoring.

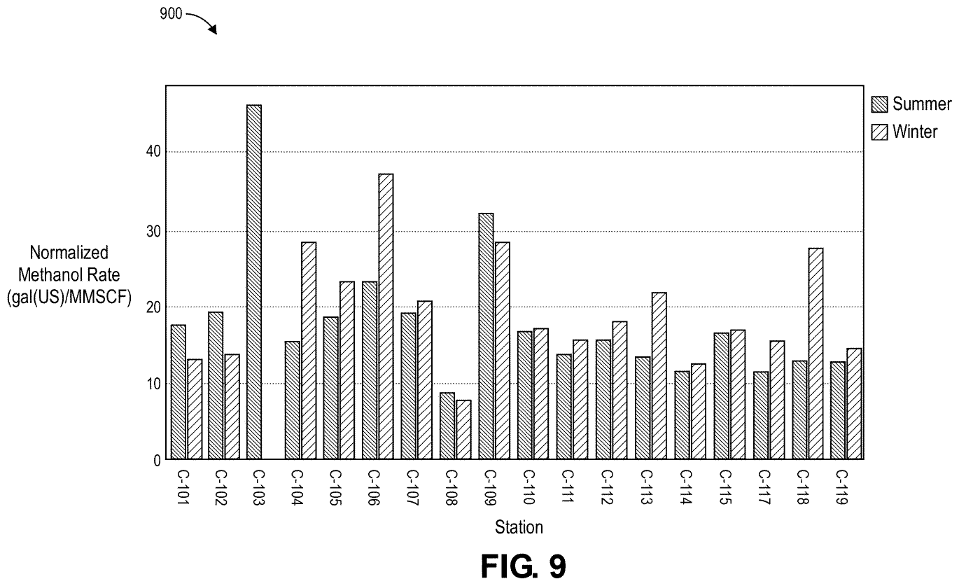

FIG. 9 illustrates a plot 900 showing a normalized methanol rate for each station in the summer and winter, according to an embodiment.
User: Please provide similar analysis for all booster stations.
AI: Reasoning: The user is now asking for methanol consumption at all stations. Use a weather API to collect historical ambient temperature during winter and summer months over the past year in Calgary, AB. Update models and spawn thermodynamic calculations with each condition concurrently. Synthesize results and provide recommendations.
   Below is a plot of the normalized methanol consumption for each station during the summer and winter months. The normalized methanol amounts indicate that methanol consumption vary from 7 to 46 gal/MMSCF, depending on the booster station and the summer/winter scenario. The amount of methanol is highly influenced by the water content and the temperature. Although the water content may not be adjusted at this point in the process, the gas distribution temperature may be manipulated by improving performance of the final cooling stage in the booster station.

The AI may also recommend, instruct, or cause a physical action to occur based upon and/or in response to the reasoning and/or answer(s). The physical action may include varying (e.g., increasing the methanol amount and/or rate introduced to each compressor booster station depending upon the information shown in the plot(s) 700, 800, 900. The methanol amount may also or instead be varied based upon the season, the water content, and/or the temperature. In a more specific example, the physical action may include actuating a chemical injection valve at compressor booster station C-106, increasing the methanol injection rate from 23 to 37 gallons (US) per MMSCF during winter months. The thermodynamic engine calculates a hydrate formation temperature of 60° F. at the station inlet. Increasing the injection rate preserves a safe temperature margin as ambient conditions decline.

### Exemplary Computing System

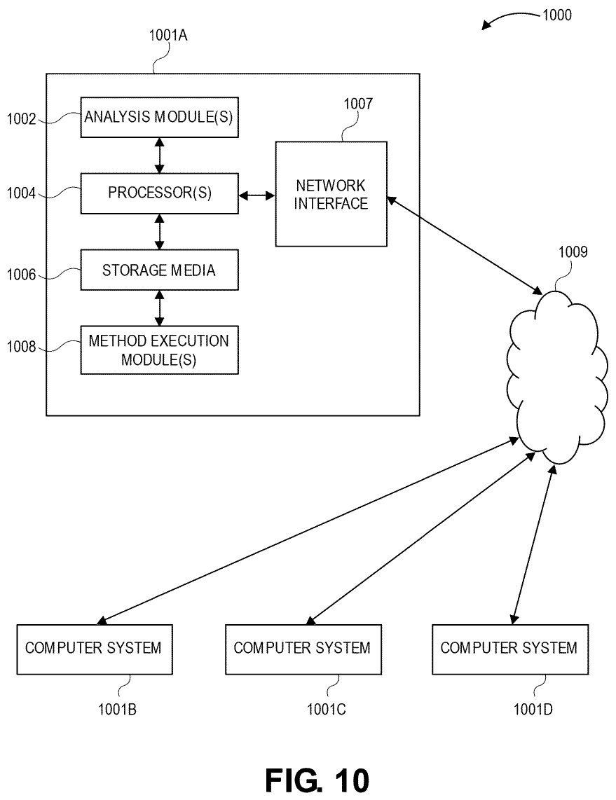

In some embodiments, the methods of the present disclosure may be executed by a computing system. FIG. 10 illustrates an example of such a computing system 1000, in accordance with some embodiments. The computing system 1000 may include a computer or computer system 1001A, which may be an individual computer system 1001A or an arrangement of distributed computer systems. The computer system 1001A includes one or more analysis modules 1002 that may be configured to perform various tasks according to some embodiments, such as one or more methods disclosed herein. To perform these various tasks, the analysis module 1002 executes independently, or in coordination with, one or more processors 1004, which may be connected to one or more storage media 1006. The processor(s) 1004 may be also connected to a network interface 1007 to allow the computer system 1001A to communicate over a data network 1009 with one or more additional computer systems and/or computing systems, such as 1001B, 1001C, and/or 1001D (note that computer systems 1001B, 1001C and/or 1001D may or may not share the same architecture as computer system 1001A, and may be located in different physical locations, e.g., computer systems 1001A and 1001B may be located in a processing facility, while in communication with one or more computer systems such as 1001C and/or 1001D that may be located in one or more data centers, and/or located in varying countries on different continents).

A processor may include a microprocessor, microcontroller, processor module or subsystem, programmable integrated circuit, programmable gate array, or another control or computing device.

The storage media 1006 may be implemented as one or more computer-readable or machine-readable storage media. Note that while in the example embodiment of FIG. 10 storage media 1006 is depicted as within computer system 1001A, in some embodiments, storage media 1006 may be distributed within and/or across multiple internal and/or external enclosures of computing system 1001A and/or additional computing systems. Storage media 1006 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media may be considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 1000 contains one or more method execution module(s) 1008. In the example of computing system 1000, computer system 1001A includes the method execution module 1008. In some embodiments, a single method execution module may be used to perform some aspects of one or more embodiments of the methods disclosed herein. In other embodiments, a plurality of method execution modules may be used to perform some aspects of methods herein.

It should be appreciated that computing system 1000 is merely one example of a computing system, and that computing system 1000 may have more or fewer components than shown, may combine additional components not depicted in the example embodiment of FIG. 10, and/or computing system 1000 may have a different configuration or arrangement of the components depicted in FIG. 10. The various components shown in FIG. 10 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 1000, FIG. 10), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for performing a flow assurance analysis in a pipeline, the method comprising:
receiving first input data related to a gas in the pipeline;
building or updating a model based upon the first input data;
receiving second input data including a query from a user;
identifying one or more topics to which the second input data is most closely related; and
generating an answer to the query using the model based upon the one or more topics.

2. The method of claim 1, wherein the first input data comprises a composition of the gas in the pipeline, a pressure of the gas in the pipeline, and/or a temperature of the gas in the pipeline.

3. The method of claim 1, wherein the first input data is extracted from data sources with different and/or unstructured formats, and wherein the first input data is extracted using optical character recognition (OCR) and/or large language models (LLMs).

4. The method of claim 1, wherein the model comprises a thermodynamic engine in a physics-based simulator.

5. The method of claim 4, wherein the thermodynamic engine is integrated into an agentic framework through a plurality of tool calls.

6. The method of claim 1, wherein the query is related to a thermodynamic property of the gas, a phase boundary of the gas, a phase envelope curve corresponding to the gas, a hydrate formation curve corresponding to the gas, a hydrate formation risk evaluation in the pipeline, an inhibitor injection rate recommendation for the pipeline, and/or a sensitivity of an effect of gas a distribution temperature and pressure on hydrate inhibitor rates into the pipeline.

7. The method of claim 1, wherein the one or more topics comprise a thermodynamic property of the gas, a phase envelope curve corresponding to the gas, a thermodynamic plot of the gas, and hydrate risk management in the pipeline.

8. The method of claim 1, wherein the identification is made by a graph-based multi-agent system including a plurality of sub-graphs.

9. The method of claim 1, further comprising displaying the answer to the user.

10. The method of claim 1, further comprising performing an action in response to the answer, wherein the action comprises varying a composition of the gas, varying a pressure of the gas, varying a temperature of the gas, actuating a valve in the pipeline, or a combination thereof.

11. A computing system, comprising:
one or more processors; and
a memory system comprising one or more non-transitory computer-readable media storing instructions that, when executed by at least one of the one or more processors, cause the computing system to perform operations, the operations comprising:
receiving first input data related to a gas in the pipeline;
building or updating a model based upon the first input data;
receiving second input data including a query from a user;
identifying one or more topics to which the second input data is most closely related; and
generating an answer to the query using the model based upon the one or more topics.

12. The computing system of claim 11, wherein the pipeline is part of a gathering network that includes a plurality of compressor booster stations.

13. The computing system of claim 12, wherein the query is related to a consumption of a hydrate inhibitor in the compressor booster stations.

14. The computing system of claim 13, wherein the consumption of the hydrate inhibitor is in specific months or seasons and in a specific location.

15. The computing system of claim 14, wherein the hydrate inhibitor comprises methanol.

16. A non-transitory computer-readable medium storing instructions that, when executed by one or more processors of a computing system, cause the computing system to perform operations, the operations comprising:
receiving first input data related to a gas in the pipeline, wherein the pipeline is part of a gathering network that includes a plurality of compressor booster stations;
building or updating a model based upon the first input data;
receiving second input data including a query from a user;
identifying one or more topics to which the second input data is most closely related; and
generating an answer to the query using the model based upon the one or more topics.

17. The non-transitory computer-readable medium of claim 16, wherein the identification is made by a graph-based multi-agent system including a plurality of sub-graphs.

18. The non-transitory computer-readable medium of claim 17, wherein a first of the sub-graphs shows a hydrate formation temperature at the compressor booster stations.

19. The non-transitory computer-readable medium of claim 18, wherein a second of the sub-graphs shows a phase envelope including a hydrate formation curve at the compressor booster stations.

20. The non-transitory computer-readable medium of claim 19, wherein a third of the sub-graphs shows a normalized methanol rate for the compressor booster stations in specific months or seasons.
